(19) United States
(12) Patent Application Publication
(10) Pub. No.: US 2011/0029538 A1
(43) Pub. Date: Feb. 3, 2011

(54) SYSTEM FOR CREATION OF CONTENT WITH CORRELATED GEOSPATIAL AND VIRTUAL LOCATIONS BY MOBILE DEVICE USERS

(75) Inventors: Daniel HARPLE, JR., South Dartmouth, MA (US); Sam CRITCHLEY, Amsterdam (NL); Rich PIZZARRO, Mechanicsburg, PA (US); Gavin NICOL, Barrington, RI (US)

Correspondence Address: WILMERHALE/BOSTON, 60 STATE STREET, BOSTON, MA, 02109, US

(73) Assignee: GeoSolutions B.V.

(21) Appl. No.: 12/510,866

(22) Filed: Jul. 28, 2009

(51) Int. Cl. G06F 17/30

(52) U.S. Cl. 707/741; 707/E17.002; 707/E17.018; 707/E17.009

(57) ABSTRACT

A system and method for a user of a mobile device or computer to easily and directly create content with correlated virtual and geospatial locations and associated context information. The content may include audio, video, and images, and be exposed via a unique URL based on content identifier. This content is indexed, including using a geospatial, “place-based” index, enabling users to easily share content with their matrix of social networks, friends, and communities, or to discover content created by others.

### CROSS REFERENCED TO RELATED APPLICATION

This application is related to the following application, the entire contents of which is incorporated by reference: U.S. patent application Ser. No.______, entitled “System for Enhanced Management of Social Networks on Mobile Devices,” filed concurrently herewith.

### BACKGROUND OF INVENTION

The present invention relates generally to creation of searchable web content with unique URLs and to content that is created by mobile device users with direct correlation to geospatial locations in particular.

### DESCRIPTION OF THE BACKGROUND ART

There is a rapidly accelerating growth in the use of the world wide web and other computer systems to store digital assets. There is also a rapidly accelerating growth in the use of mobile devices, and in particular, mobile devices that have the ability to derive the current location of the user. There is further a rapidly accelerating growth in using the world wide web to not only manage digital assets, but to model real world systems in a computer analog.

Most modern methods of creating digital assets are limited in three key areas: creation tools are restricted to larger devices, offer a poor model for content creation, and content is typically created devoid of context.

The restriction of content creation to larger devices fails to meet the demands of mobile device users. For people that that do not have a larger device, such as a desktop PC, the content creation experience to date has typically been very poor. While this demographic has largely been restricted to Eastern or European countries, there is a clear growth in mobile use worldwide, amongst all age groups, and hence, clear demand for change.

As the number of mobile device users increases, the type of application in demand, and the type of content being created is undergoing significant change. A clear example can be seen with cell phones: in the early days of cell phones, usage was typically restricted to calling people and managing a small contact list. As cell phones became more powerful and more pervasive, users started to use them for additional things, such as texting and email. Modern cell phones have become intensely personal devices, and are increasingly used for entertainment, and for social activities, in addition to more traditional use. In many cases, the devices do not provide a natural means for people to create content that reflects their interests. This has led to a mass exodus of users to platforms that are less restrictive, but even so, there is impedance.

Part of the impedance is due to the limited ability of mobile devices to capture or model the context of the user or the content they create. For example, capturing a photograph is of less use than capturing a photograph with the event and location associated with the photograph as context. Increasingly, as people expect to share content, and as the content becomes more personal, context becomes more important. Chief among facets of context are social context, temporal context, and increasingly, geospatial context. Current mobile content creation suffers in one or more of these areas.

Despite best efforts to date, it is clear that there is pent-up demand for a system that tackles the three areas of weakness outlined above. The system needs to simplify capture of the content users desire, and to capture it in context. Increasingly, capturing in context means to bridge the digital and physical divide with digital content being bound to a geospatial location.

### SUMMARY OF INVENTION

The present invention provides a system and method for capturing content in context, and to make that content available to others with the context intact. One use of such a system, but not the only one, is as a mechanism for using mobile devices to capture media assets, such as images, audio, and video, and to make those media assets sharable and searchable.

The system of the present invention includes a content capture device, a content storage manager, a content metadata manager, an indexing mechanism, and a mechanism for exposing the captured content.

The content capture device captures the user generated content, and the context in which is it created. This context includes, but is not limited to, social information, temporal information and geospatial information. Additional information may include descriptive text, or descriptions of the temporal and geospatial information.

The content storage manager provides the ability to store arbitrary data by associating an identifier with the stored data. The content storage manager also provides the ability to later access the content, or portions thereof. The content storage manager may also provide the ability to replace the content totally, to modify the content, or to remove all storage associated with a given identifier.

The content metadata manager provides a means for storing a set of properties associated with a given identifier, and to thereby capture the context of the content. The properties themselves will have an identifier and a data portion such that using the identifier, the data can be retrieved, or otherwise modified. The content metadata manager may choose to augment the metadata associated with a content item automatically, such as by taking the location of a content item, and automatically assigning it to a greater geospatial context, such as city, state and country.

The indexing mechanism is used to provide quick access to a content item based on its captured context, metadata, or content, and to provide greater contextual information, such as relationships between content items. One key facility is to provide indexing of the geospatial context such that searches by proximity become possible.

The mechanism responsible for exposing the captured content provides a means for accessing the content after creation. This includes, but is not limited to, exposing the content via the world wide web using a unique URL derived from the content identifier, which provides a direct correlation between physical geospatial locations, and virtual locations.

In one embodiment of this invention, the content capture device is a mobile device with GPS or other means to derive location, and the content exposure mechanism is a web server that serves content in the context of a map whereby a user may explore captured content in its geospatial context.

In another embodiment of this invention, the content capture device is a mobile device with GPS or other means to derive location, and the content exposure mechanism is a web server that provides a means to find content by using the indexing mechanism such that content matching criteria, including, but not limited to, proximity to a given location may be found and displayed.

In yet another embodiment of this invention, the content capture device is a mobile device with GPS or other means to derive location, and the content exposure mechanism is a web server that provides a means to share content in the context of a social network.

### BRIEF DESCRIPTION OF DRAWINGS

FIG. 1 shows the system according to an aspect of the invention and all major components.

FIG. 2 shows an example of a content capture device and its major features.

FIG. 3 shows an example of a content exposure mechanism and its major features.

FIG. 4 shows the system according to an aspect of the invention and all major components, and a typical flow of information between components during the content creation and content retrieval processes.

### DETAILED DESCRIPTION

The present invention(s) will be described with a particular set of embodiments of the components assumed in the context of management of content captured using a mobile device, and exposed using a web server, though other embodiments and contexts are possible.

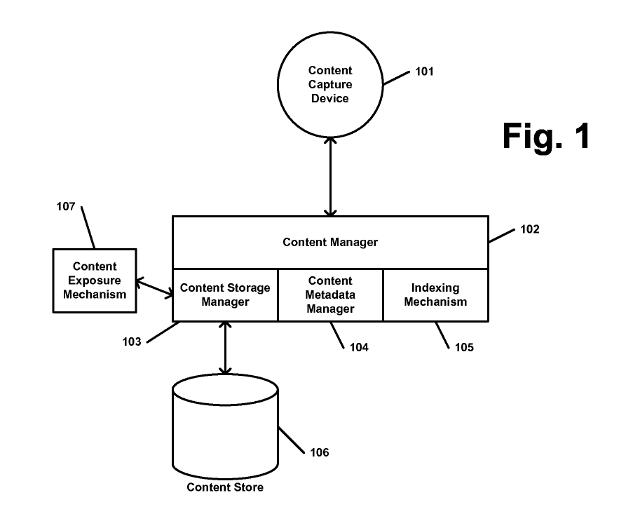

FIG. 1 shows a high-level diagram of an aspect of the invention, including content capture device 101, content manager 102, content storage manager 103, content metadata manager 104, indexing mechanism 105, content store 106, and content exposure mechanism 107. Content capture device 101 may be a mobile device, or even an arbitrary computer program. The key requirement is that device 101 provide a means to easily capture content and the associated context, including, but not limited to the geospatial, temporal and/or social context. In a preferred embodiment, the content capture device will be a mobile device, such as a cell phone, that can capture content for example by a built-in camera and/or microphone. Device 101 also preferably has some means of determining current location, such as by having an embedded GPS unit, running a software application that provides the additional content capture capabilities.

There are a large number of possible embodiments of content manager 102, content storage manager 103, content metadata manager 104, and indexing mechanism 105. In a preferred embodiment, content manager 102 is a device using a network protocol such that content capture device 101 may use typical networking technologies, such as TCP/IP, to communicate with content manager 102. This allows content capture device 101 to be entirely mobile; the only requirement is a network connection. Also, in a preferred embodiment, content storage manager 103, content metadata manager 104, and indexing mechanism 105 are applications using relational databases, augmented by file systems for storage of large media assets and additional indexing mechanisms enabling fast geospatial retrieval or for clustering related content in order to later retrieve content using temporal or social qualifications.

In one form of a preferred embodiment, content manager 102 and content exposure mechanism 107 are software applications running within a web server. In such an embodiment, content manager 102 will allow content capture device 101 to submit content items to content manager 102 using the HTTP protocol, and content exposure mechanism 107 is a web application that allows HTTP clients, such as web browsers, to view or otherwise interact with created content items. This has the effect of enabling mobile device users to create World Wide Web (WWW) content where a virtual location on the WWW is correlated to a physical, geospatial location.

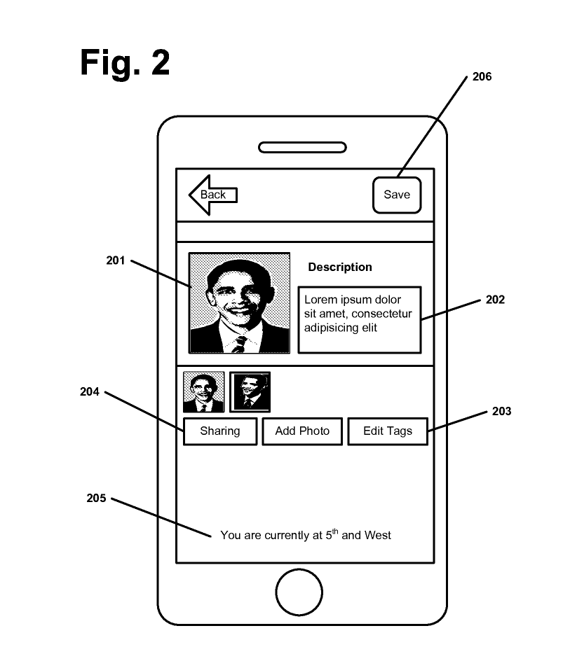

A nonlimiting example of content capture device 101 is shown in FIG. 2, where content capture device 101 is a modern cell phone. FIG. 2 illustrates content capture area 201, metadata capture areas 202, 203, and 205, including description 202, tags 203, and geospatial context capture 205, as well as means to store content 206. Temporal context capture is implicit. For example, when content capture device 101 captures content, it also preferably captures an indication of the time, such as a timestamp. For example, a timestamp is a simple way to capture temporal context at the moment the content is created. A software application installed on content capture device 101 uses a built-in camera and microphone to respectively capture content such as images and audio recordings, with the images being displayed in content capture area 201 as well as additional information, including, but not limited to descriptive text 202, associated additional metadata in the form of ‘tags,’ or keywords, 203, and rules governing how the content is to be shared, 204, within a social context. Tags, or keywords, 203 can be entered by the mobile device user. The mobile device user can select how to share the content, for example by sharing with the public or by sharing with a limited class, group, or list of people. The software application further provides the means to capture, 205, the geospatial context, by using built-in features, such as the GPS unit, or by using application-level techniques, such as WIFI triangulation or IP lookup. The content capture process is not simply capturing the content, but also the context: geospatial, temporal and social. The social context is provided by descriptive text 202, which may be entered by a user, and which may be used to describe a location or event such that a geospatial location is associated with content in a way that facilitates creation of a correlated virtual location, and by the rules specifying how the content is to be shared 204. For example, the social context could be “Fishing on Lake Taupo with John.” The descriptive text that makes up the social context in this example describes not only the content, but also the context of the content. Finally, the application provides a means for the created content item to be saved 206. In a preferred embodiment, the act of saving the content item will include transmitting the content over a network protocol, such as HTTP, to content manager 102 at a central site.

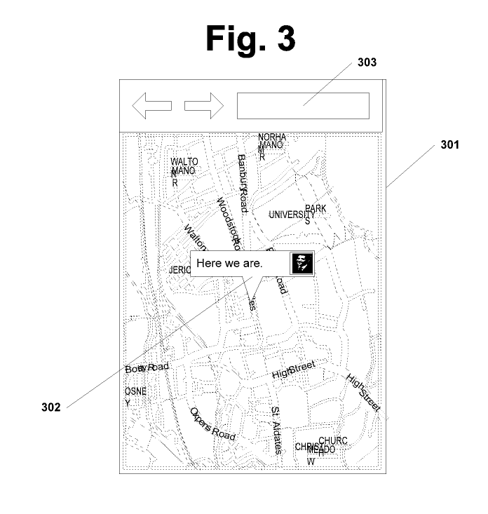

FIG. 3 shows an example of a content exposure mechanism and its major features, including geospatial context display 301, content item 302, and means to find other content items 303.

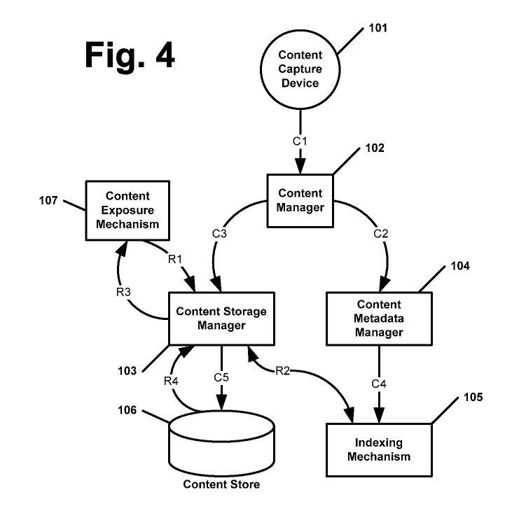

FIG. 4 shows the system according to an aspect of the invention and all major components, and a typical flow of information between components during the content creation (C1 thru C5) and content retrieval processes (R1 thru R4). Content capture device 101 transmits content to content manager 102 as shown in FIG. 4 in step C1. Content manager 102 will then forward the content to content storage manager 103 in step C3 and to content metadata manager 104 in step C2. Having received the content item, content storage manager 103 will commit, in step C5, the content to persistent content store 106. Content storage manager 103 preferably uses a combination of a relational database and a shared file system as persistent content store 106. A relational database is used to store information about the content, such as creation date, identifier of the user creating the content, etc. while the file system is used to store the content, though the content (images, audio, etc) may, in another embodiment, be stored within a database. In addition to storing the content captured by content capture device 101, content storage manager 103 may store derived media assets such as thumbnails, or down-sampled versions of audio and video. In a preferred embodiment, these derived content items are captured as content items that have an association to the original content stored as part of the associated information stored in the relational database. Content storage manager 103 associates a unique identifier with the content, which can then be used to provide content exposure mechanism 107 with a means to expose the content uniquely. This has the effect of creating a canonical 1:1 relationship between a virtual location that is correlated to a physical, geospatial location. The content item preferably has a unique URL associated with it, uniquely identifying it within the WWW.

Content metadata manager 104 stores additional information about an uploaded content in order to more completely capture the creation context, or to augment the created content such that it is placed into a more complete context than that captured by content creation device 101. An example of such augmentation is to perform a reverse geospatial lookup of the supplied location in order to associate address information with the created content. Another example is to use the supplied or derived context to find other content items that are associated, for example, proximally, temporally, or socially. For example, all content items at the same address may have a relationship added to them. A further example is to perform WWW searches, and to automatically add relationships to web pages to the content item. For example, a content item describing a restaurant may automatically have a relationship to an online review added to the associated metadata.

Context data and metadata are related, but are generally not identical. Context data is used as an input in order to derive metadata. As an example, descriptive text or image recognition might be used to extract metadata, such as category, from the content item. Having extracted and augmented the metadata associated with a content item, content metadata manager 104 will then transmit, as shown in step C4, the metadata to indexing mechanism 105, which indexes the content and metadata for retrieval purposes in the future. Indexing mechanism 105 preferably uses a combination of indexing technologies, including relational databases, full text indexing engines, and geospatial indexes. Indexing mechanism 105 indexes the metadata for fast retrieval in the future, and also indexes the relationships between content items, and users and other content items, thereby providing a means to query on more than just the values stored in the metadata. For example, indexing mechanism 105 enables content exposure mechanism 107 to retrieve content items that are associated with a particular user, or a particular group of users.

Once the content item has been captured, stored and indexed, in steps C1 thru C5, it is then available to be retrieved. In FIG. 4 the content can be exposed over the World Wide Web by content exposure mechanism 107. The unique identifier provided by content storage manager 103 is used to uniquely identify the content item. In the context of content exposure mechanism 107 that exposes content to the WWW, the unique identifier is used to create a URL that uniquely identifies the content item. FIG. 3 shows how this might be presented to a user: content item 302 is presented in the context of geospatial content display 301, as illustrated in FIG. 3 as a map, thereby recreating the geospatial context information for the user.

The content is retrieved by a device connecting to content exposure mechanism 107. If the device is a mobile device, such as a cell phone, a subset of the content may be retrieved and exposed to the user. If the device is a computer running a web browser, more information may be retrieved, thereby allowing more of the context to be displayed. Regardless of the requesting device, content exposure mechanism 107 uses information available from the device request to derive the unique identifier and to then contact, in step R1, content storage manager 103. Content storage manager 103 will then return the content to content exposure mechanism 107 in bi-directional step R3, and content exposure mechanism 107 preferably will then decide the most appropriate way of exposing the content. Content exposure mechanism 107 is preferably a web application that accepts requests for URLs from clients, such as web browsers. Content exposure mechanism 107 can also create web pages that display the content item in a rich context, including the social, temporal and geospatial context.

In some cases, a client of content exposure mechanism 107 may wish to retrieve multiple content items grouped according to context information, such as when retrieving content items by proximity to a location. In such cases, the request will result in content storage manager 103 sending, in step R2, context information to indexing mechanism 105, which, using the context information, will return, in step R2, the identifiers of the content items that most suitably meet the desired context criteria. Content storage manager 103 uses the unique identifiers to retrieve content items from content store 106 that are then returned to content exposure mechanism 107 which in turn will determine the best way to expose the information to the client. In addition to proximity, other indexed criteria can be used to group content items: for example, items that share metadata tags could be displayed via a ‘tag cloud’ visualization within a web browser.

By offering a means to capture content in its full context, geospatial, temporal and social, the current invention provides significant advantages to content creators. In particular, if content creation is taking place on a mobile device, this invention provides a means to easily capture more context information than has previously been possible, and in doing so fulfills the needs of the increasingly mobile world population. In addition, because the content is captured with a rich context, including the geospatial context, it is possible to bridge the gap between the physical and virtual worlds by creating correlated locations bound by a unique identifier for the created content. This simplified sharing or other reuse of content items leads to a richer, more vibrant experience.

1. A system for capturing content in context and for making the content available to others with the context intact, the system comprising:
a content storage manager for storing and accessing user generated content and associated context captured by a content capture device;
a content metadata manager for associating additional context with the user generated content; and
an indexing mechanism for providing access to stored user generated content and associated context.

2. The system of claim 1, wherein the user generated content includes at least one of still images and video.

3. The system of claim 1, wherein context includes temporal information and geospatial information.

4. The system of claim 1, wherein context includes social information.

5. The system of claim 2, wherein context further includes text describing at least some of the content.

6. The system of claim 1, wherein the indexing mechanism is capable of associating stored user generated content and associated context with a physical location.

7. A method of receiving content in context and for making the content available to others with the context intact, the method comprising:
receiving user generated content and associated context;
storing the received content and associated context;
associating an identifier with the stored content and associated context;
indexing the stored content and context based on at least one of content, metadata, and context; and
providing access to indexed stored content and associated context.

8. The method of claim 7, wherein the user generated content includes at least one of still images and video.

9. The method of claim 7, wherein context includes temporal information and geospatial information.

10. The method of claim 7, wherein context includes social information.

11. The method of claim 10, wherein context further includes text describing at least some of the content.

12. The method of claim 7, further comprising associating indexed stored content and associated context with a physical location.

13. The method of claim 7, further comprising storing additional context associated with the identifier.
